(19) United States
(12) Patent Application Publication
(10) Pub. No.: US 2013/0145319 A1
(43) Pub. Date: Jun. 6, 2013

(54) INTERACTIVE ELECTRONIC CATALOG APPARATUS AND METHOD

(71) Applicants: Joseph Hyman Wein, Highland Park, IL (US); Richard M. Jagisch, Chicago, IL (US); George White, Chicago, IL (US); Marc Cain, Chicago, IL (US)

(72) Inventors: Joseph Hyman Wein, Highland Park, IL (US); Richard M. Jagisch, Chicago, IL (US); George White, Chicago, IL (US); Marc Cain, Chicago, IL (US)

(73) Assignee: PADALOG LLC, Chicago, IL (US)

(21) Appl. No.: 13/704,442

(22) PCT Filed: Jun. 17, 2011
(86) PCT No.: PCT/US2011/040881

§ 371 Date: Feb. 25, 2013

Related U.S. Application Data
(60) Provisional application No. 61/356,385, filed on Jun. 18, 2010.
(60) Provisional application No. 61/431,642, filed on Jan. 11, 2011.
(60) Provisional application No. 61/492,188, filed on Jun. 1, 2011.

(51) Int. Cl. G06F 3/0482

(52) U.S. Cl. CPC G06F 3/0482
USPC 715/811

(57) ABSTRACT

An interactive electronic display of a plurality of inventory items across a distributed network has a database having information for each of a plurality of display items. A processor is configured to organize at least one electronic catalog of display items, said catalog being distributable across the distributed network such that at least one user computer with access to the network may access the catalog. Instructions may be received from the user and the catalog changed according to those instructions. Further changes in the catalog may be entered from the publisher in response to an editorial change entered by a user, according to preconfigured directions. The display of the catalog may be controlled by a user with a graphical user interface such that the user may toggle between different catalogs or different displays of a catalog, which may be a different layout or a different color.

### BACKGROUND OF THE INVENTION

1. Field of the Invention

The present invention is in the field of electronic display of pluralities of items, such as inventory items, particularly a plurality of tablet computers or mobile communication devices, with interactive displays responsive to user selections.

2. Related Art

The interoperability of distributed network shopping and purchasing displays of items offered for sale over distributed networks such as the internet has to date been limited to placing an order for a displayed item, giving ranking or review feedback about a particular item, and sending emails to sellers. Options and opportunities for the publishers of groups of items for sale on line are disadvantageously limited. Options and opportunities for the viewers/customers on distributed networks to interact with and alter a group of items being considered for purchase is also limited.

Moreover, electronic commerce developments have been largely directed towards eliminating middle men such as salespersons and manufacturer's representatives. Little or nothing has been done to supplement and aid salesmen and manufacturer's representatives, despite the value they are capable of adding through their knowledge of the customer. For sales presentations and management of relationships with retailers who purchase a line of products from a manufacturer or wholesaler, the salesman or representative remains burdened with the disadvantages of old style manual catalogs and samples, which are cumbersome and slow to change together with the disadvantages of modern ecommerce, which do not provide adequately for customization of presentation material to particular potential purchasers of a line of products.

### SUMMARY OF THE INVENTION

The present invention is a configuration and response protocol and system and a display protocol and system as executed on network access machines such as mobile computing and communication devices, for example tablet computers, iPads, PDAs and internet-accessible cellular telephones. The apparatus, system and method of the present invention may be embodied and executed with the tablet computer engaged with a network such as the Internet or disengaged from it.

An interactive electronic display of a plurality of inventory items across a distributed network has a database having information for each of a plurality of display items. The information in the database may further be grouped into configurable fields. A processor (including but not limited to a browser) is configured to organize from the database at least one electronic catalog of display items, said catalog being distributable across the distributed network such that at least one user computer with access to the network may access the catalog. Instructions may be received from the publisher and/or the user and the catalog changed according to those instructions. Further changes in the catalog may be entered from the publisher in response to an editorial change entered by a user, either manually or automatically according to preconfigured directions.

The display of the catalog may be controlled by a user with a graphical user interface such that the user may toggle between different catalogs or different displays of a catalog, which may be a different layout or a different color. Further, one graphical user interface may be located within a browser and used by a publisher, and a second graphical user interface may be located within a display device and used by the user.

The present invention further advantageously provides electronic presentation support for salesmen. Salesman presenting to a particular retailer who may purchase a line of products may access and customizably configure catalogs in order to tailor which specific items may be presented to the retailer, in what format, with what supplemental information and with what potential sales/price/quote offers the salesman may be authorized to present. In this fashion a salesman may advantageously leverage his knowledge of a particular retailer being called upon.

The present invention includes a novel and advantageous display algorithm for display of large data volume catalogs on smaller capacity devices comprising a display of an item for sale while only a next item and previous item are loaded for next display into random access or short term memory.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a block diagram of the components of the system of the invention.

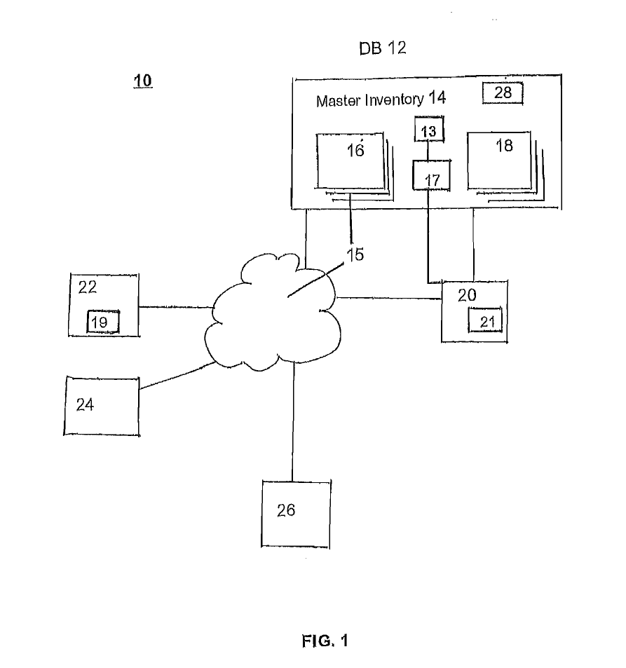

FIG. 2 is an exemplary display of the system.

FIG. 3 is a representative screen shot from the system.

FIG. 4 is a representative screen shot from an auction using the system.

FIG. 5 is a representative screen shot from an auction using the system.

FIG. 6 is a representative screen shot from services using the system.

FIG. 7 is a representative screen shot from services using the system.

FIG. 8 is a representative screen shot of a system billing embodiment.

FIG. 9 is a representative screen shot of a system billing embodiment.

FIG. 10 is a representative screen shot displaying multiple catalogs.

FIG. 11 is a representative screen shot from the system.

FIG. 12 is a flow chart depicting the creation and publication of a catalog.

FIG. 13 illustrates a tag creation matrix on a catalog creation page.

FIG. 14 depicts a sale item loading screen.

FIG. 15 depicts a catalog display of a matrix of tagged data about displayed items for sale.

FIG. 16 is a flow chart depicting the accessing of a catalog by a salesperson.

FIG. 17 is a flow chart depicting an algorithm for display of a catalog.

FIG. 18 is a representative screen shot showing tagged catagories.

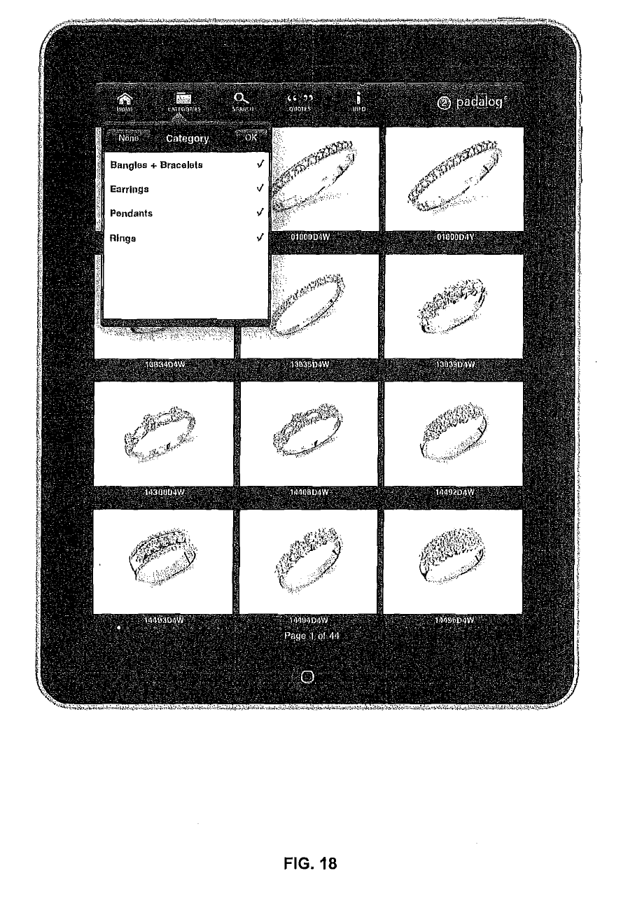

FIG. 19 is a representative screen shot showing a quote screen with send capacity.

FIG. 20 is a depiction of an alternate field/tag creation page.

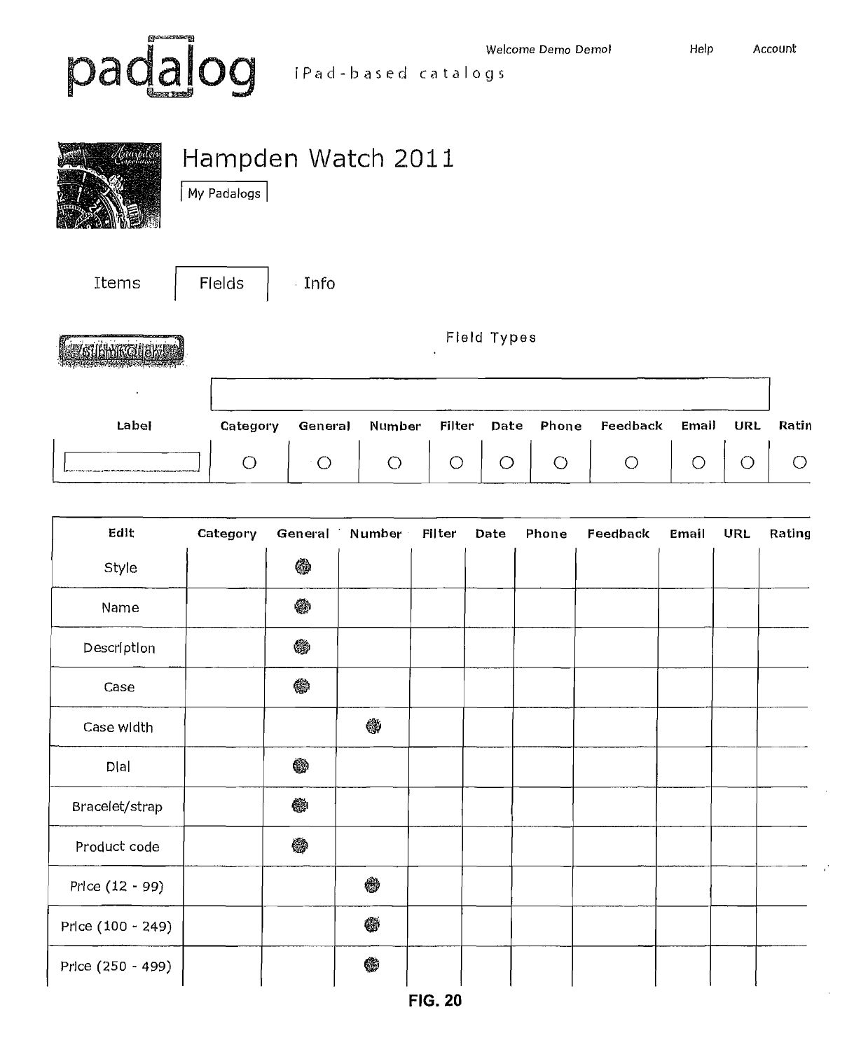

### DETAILED DESCRIPTION

Referring now to the drawings wherein like reference numbers indicate like elements, interactive electronic catalog system 10 includes a database 12 having a master inventory 14. The database 12 may be divided in a configurable fashion into catalogs 16, 18 by a publisher, who may for example be a seller of items in the inventory. inventory items may be products or services. The master inventory may be divided into a plurality of private catalogs 16 and public catalogs 18. The configuration, population and updating of the catalogs by the publisher may be done through any network access, as for example through a browser accessible by a mobile device 20 operated by the publisher having the requisite access security identifiers and passwords.

The catalogs 16, 18 may have configurable data fields 13. Each field 13 may have configurable attributes including but not limited to a name, number of characters, alphanumeric requirements, privacy settings, encryption, or any other attribute technically capable of being associated with a field 13 in a database 12 that may be but is not limited to being a relational database. These data fields comprise the data architecture for the public and private catalogs. Publishers could block certain fields from viewing by users, such as wholesale price, for example. Other aspects such as attachments, items, even whole catalogs may be blocked as well. Blocking may be by user name and password, challenge questions, biometrics, IP address, UDID, tokens and/or a dongle or physical key.

Viewing the electronic catalogs 16 and 18 would be the publisher, and end-users of the system who may for example be salespersons, retailers or consumers seeking to buy items from those listed in the catalogs. The end-users would access the system through their own network access machines, such as for example mobile devices 22, 24 which may constitute computers having internet access or mobile devices such as tablet computers, iPads, PDAs, cell phones, iPads and the like.

Alternatively or additionally, the ultimate end user, who may be a retailer considering the purchase of a line of products, may view the catalogs on the mobile device of a salesman. Either public catalogs, 18, i.e., those identical with catalogs published on the website of a catalog publisher/wholesaler/vendor of the items for sale or a private catalog 16 offered by the vendor only to retailers of the products.

Other parties may have access to the system. For example, third party commenters and viewers, whose access would also be through a network access machine such as an iPad, tablet computer, PDA or smart cell phone 26.

Each of the parties, catalog publisher, user and commenters, may have varying degrees of access, interoperability, communication and viewing rights, as may be preconfigured by the publisher.

### Catalog Creation

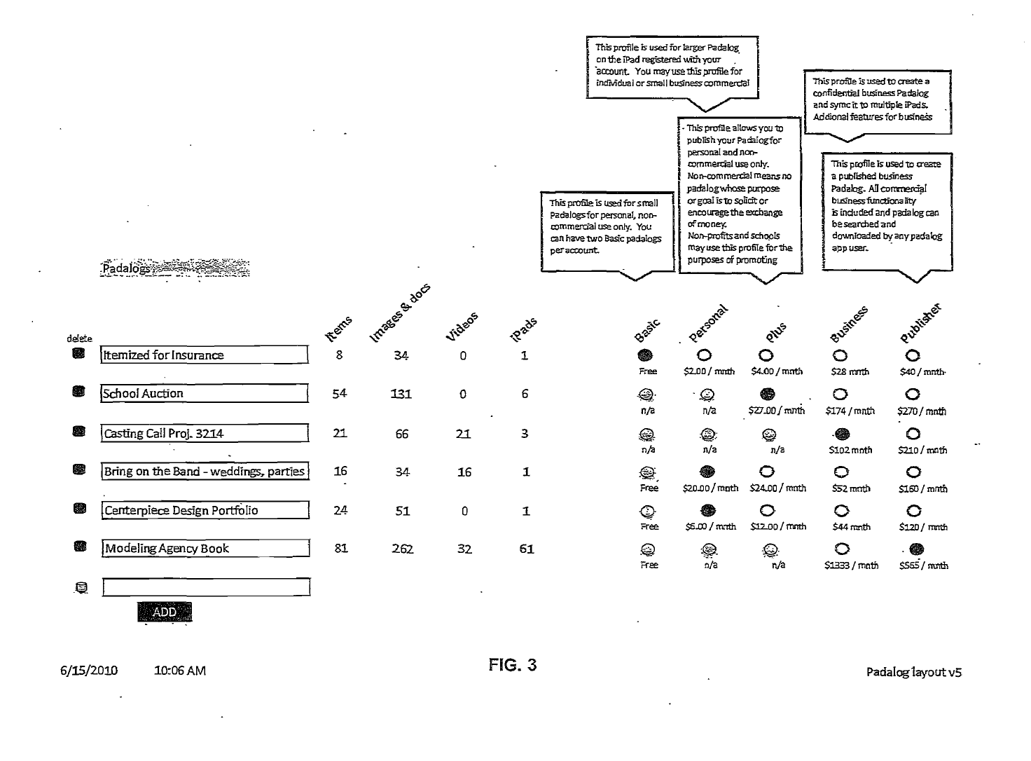

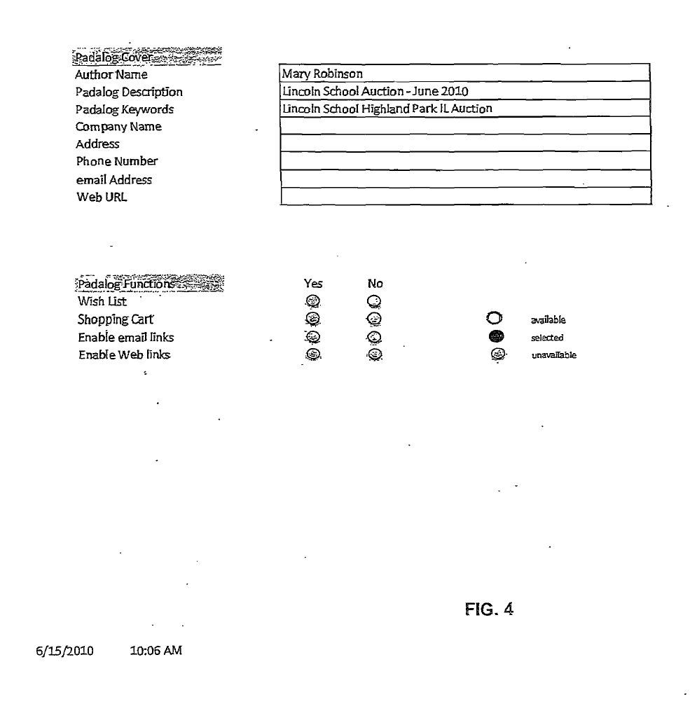

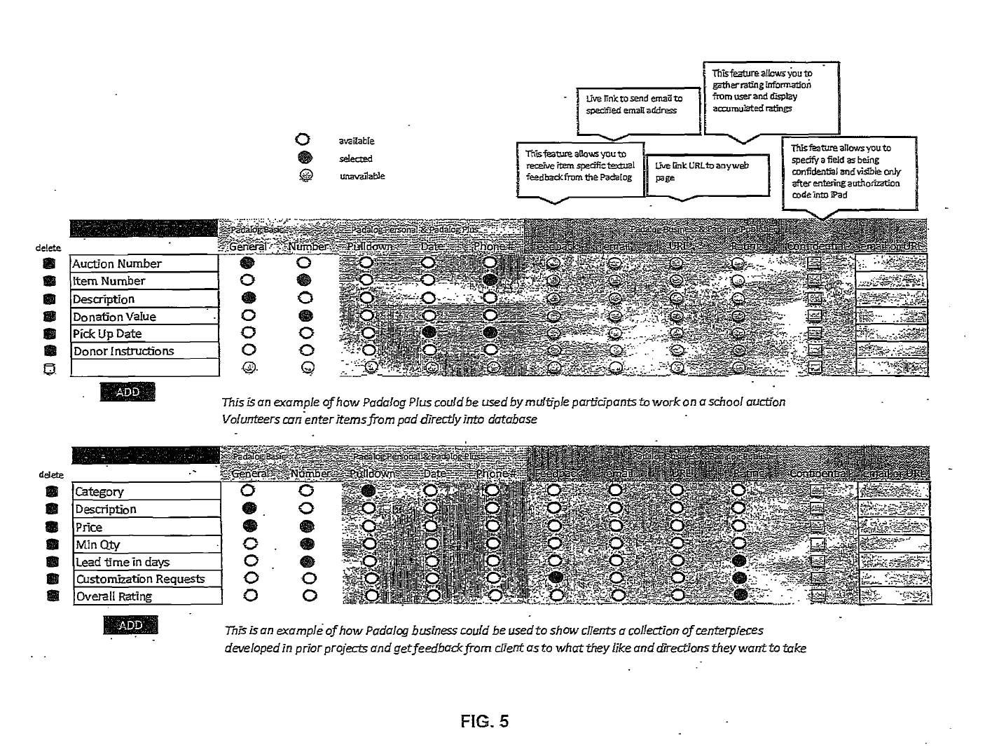

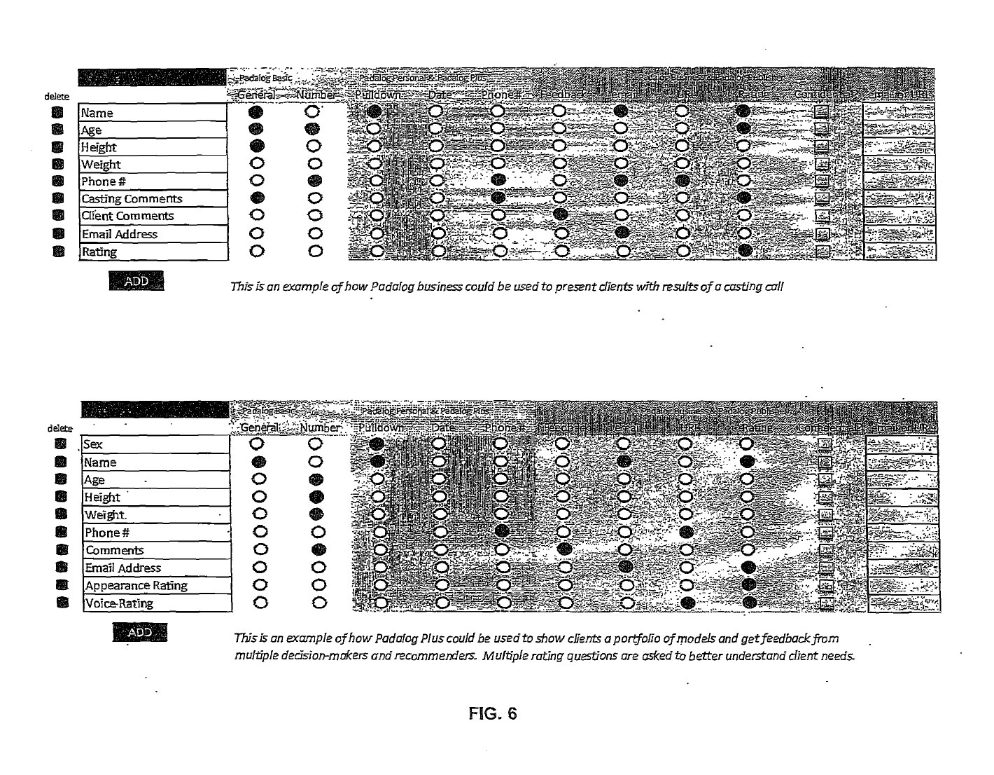

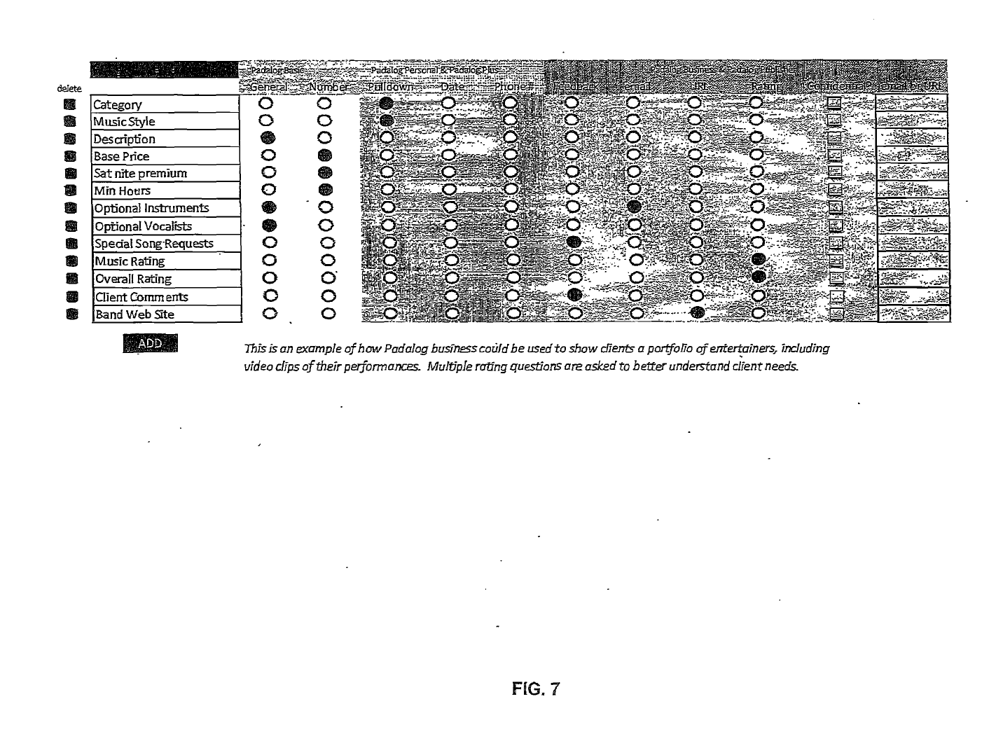

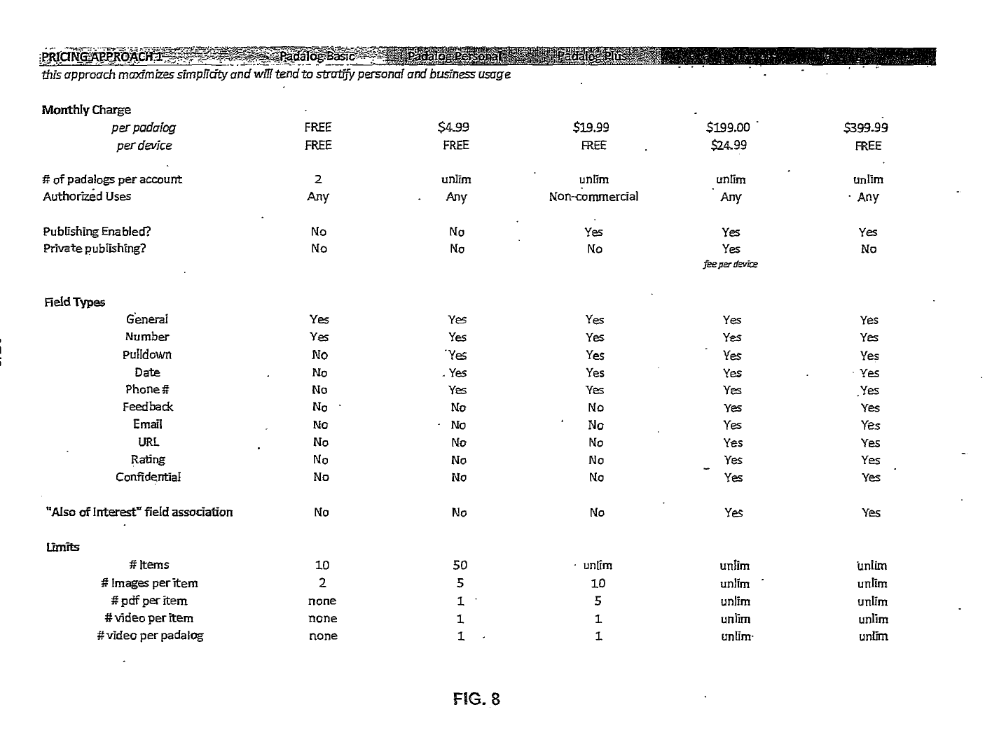

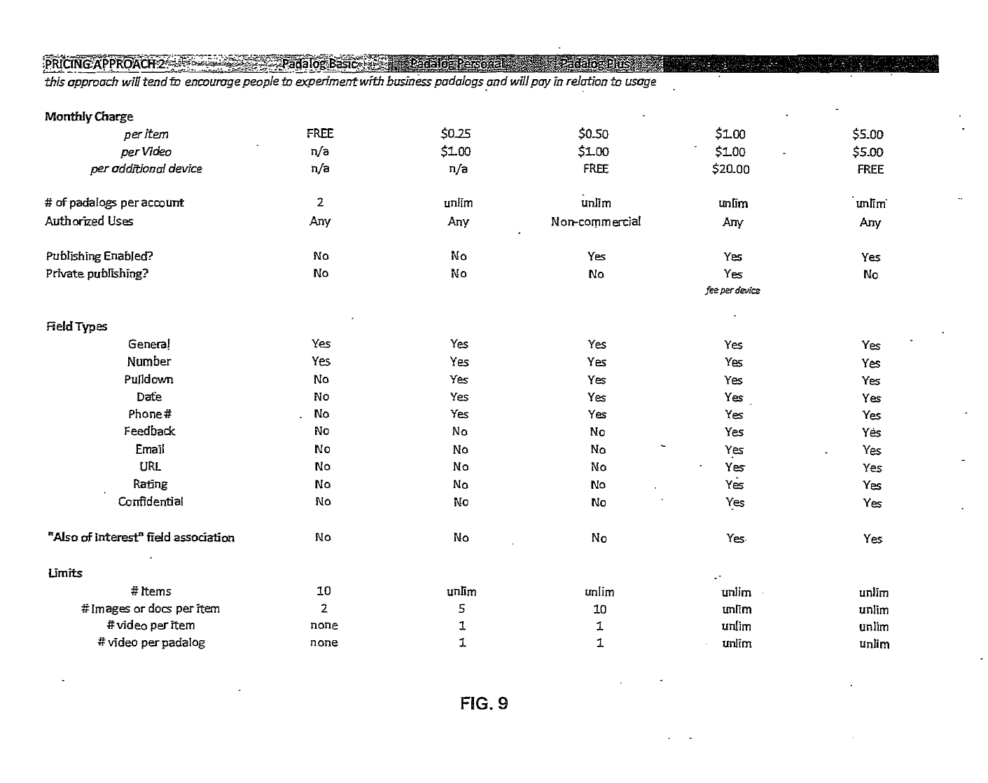

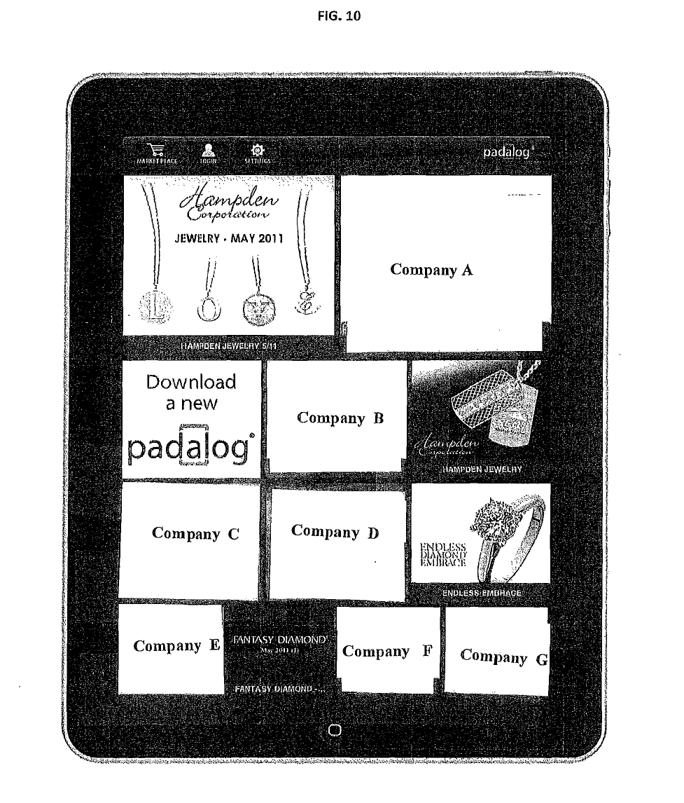

The publisher may designate any of a variety of fields for use by the users. Exemplary fields are shown without limitation in FIGS. 3 through 10. Catalogs may be public, in which case they may be accessed and viewed by anyone with network access, or catalogs may be private, in which case they may be viewed only by users designated by the catalog publisher. The fields may have associated attributes, such as passwords, encryption, blocking from user view, ability to rate, certain alphanumeric requirements, and category identifiers. To facilitate creation of a catalog, the fields and attributes for each field may optionally be selected by the publisher using menus. The catalog further includes both keyword and image search functions and an ability to populate fields with data of any kind including but not limited to images, links to websites, text and sound, which data may optionally be downloaded from networked devices or the internet.

The publisher may optionally restrict a user's ability to copy or distribute a catalog or data within the catalog.

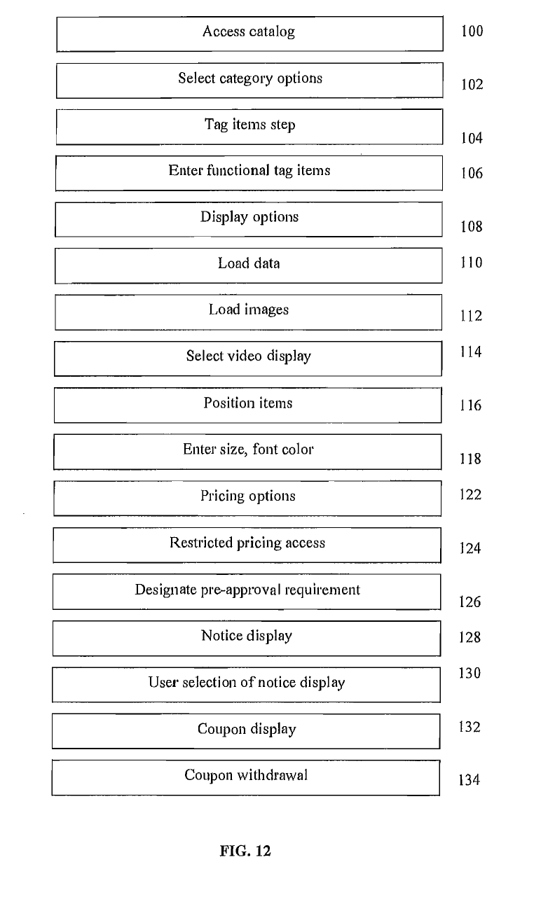

Referring now to FIG. 12, a catalog publisher may post, configure and manage an individual catalog in the following manner. Previously, the publisher will have downloaded the application of the present invention in order to make the following functionality accessible. The application may be directly loaded onto a general purpose computer owned and operated by the catalog publisher, or may be maintained on a separate browser accessible by the publisher through a network such as the Internet. In a first step 100 the publisher accesses the application (see, FIG. 12). The access may include familiar steps and requirements such as entering a user ID and password. Thereupon the publisher selects a start page for publishing a “catalog.” “Publishing” as used herein means loading data and images to a memory as described herein.

Once initiated, a catalog publication session provides a publisher with a menu of options, many of which have scaled sub options. (In one aspect of the present invention, billing to publishers for use of the present invention would be by their selection of options and/or loading of data to build catalogs and take advantage of the options.)

First the catalog must be organized. A first option is the categorization of the items to be displayed in the catalog. For example a vendor/wholesaler of clothing may want to have high level categories for men's and women's clothing, and/or for shirts/blouses and pants/skirts and/or separate groupings for shoes. In one aspect of the invention, sub categories such as sizes and colors may be selectable. Hence in one embodiment of the invention a hierarchical category and subcategory structure may be used. Categorization is largely unrestricted. For example an auto parts wholesaler may wish to create groups according to preferred providers, private labels, or particular retail chains to whom items are offered. The publisher identified categories by naming them in a field provided. Each category is populated by loading images and data as described herein and associating the images and data for each item with its category.

Organization may be further detailed by the process of tagging each catalog item. Tagging advantageously enables both categorization and searching. After categorization and before loading data a number of tags may be identified by the publisher by filling in fields provided therefore on a configuration page. Tagging the Padalog is different than the provision of metatags or key words for internet searching for the Padalog website or the Catalog Publishers website, which is separate, and loaded according to known methods.

In one embodiment of the invention, tagging for the catalog being published includes two types of fields for tagging. The first is pre-configured for each catalog such that each item for sale loaded into a catalog by a catalog publisher will have at least the following tags: title, description, price and the item's unique product identifier number or “SKU.”

The second type of field for tagging is optional. Optional tagging fields may be selected by the catalog publisher for data display in addition to the mandatory tags. A novel and advantageous aspect of the present invention is that the number of optional tags is entirely scalable; the catalog publisher may choose none or many. Further, both the identification and the content of the optional tags are entirely at the catalog publisher's discretion. Hence, a publisher of a catalog for garments may choose to create tags indicating that an item for sale is for men or women, the size, available in certain colors, and the like. Alternatively, a publisher of a catalog for watches may create tags for description of the watch case, description of the watch dial, the bracelet or strap, and the like. A publisher of a catalog for models may create tags for the model's measurements, height and weight. A publisher of a catalog for motorcycles may create tags for engine size, range of tires available for the motorcycle, customization options, and the like. In some circumstances such as custom made goods as for example provided by tailors or bakers, delivery time may be indicated. For other products such as are maintained in inventory, a number in inventory may be included in the product data.

The creation of tags is as follows. The catalog publication page on the website of the present invention has a “new tag” option to add a new tag. When selected, the publisher is presented with a “label” field into which he may type anything he or she wants; size, color, etc. The newly created tag will become one of the labels for a row in a matrix of tags for that catalog, joining the mandatory title, description, price, and SKU rows.

At the tag creation step, each row runs across a number of columns, whose headings, in one embodiment of the invention, may include category, general, number, filter, date, phone, feedback, email, URL and rating. For each tag row, the catalog publisher selects one column designation for that row. Most tags describing the product features would be designated as general. General designations will contain simply descriptive text in the ultimate catalog. Others will be numbers, such as for example dimensions, prices or a number available in inventory.

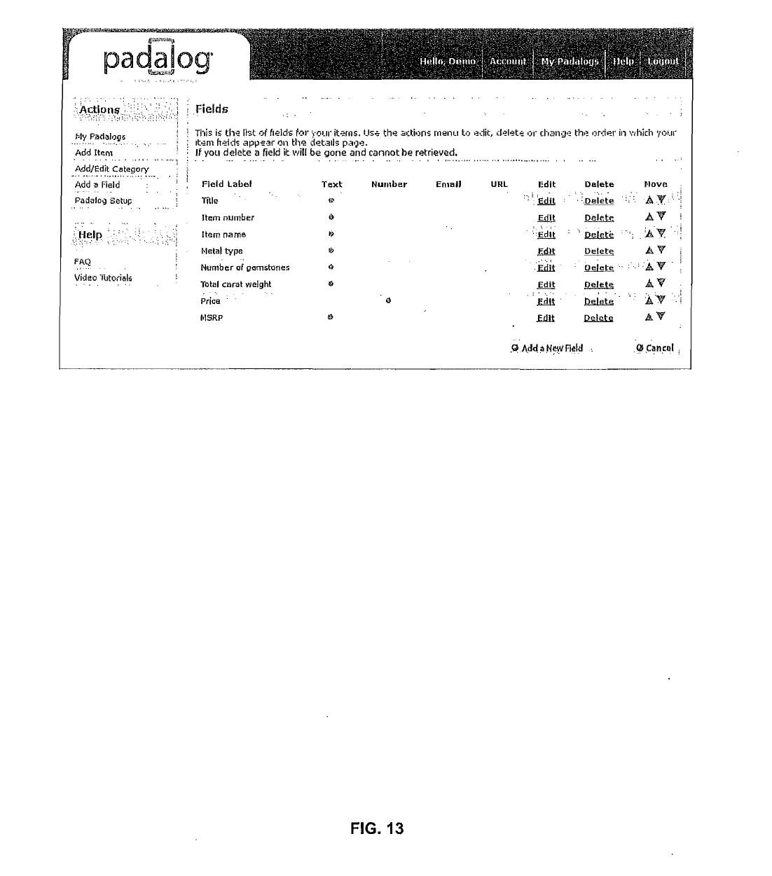

Some tags are associated with functionality. So, for example, emails, phone numbers, URLs and ratings, when selected, create links in the catalog itself which links are associated with certain executable code for the appropriate function. For example, a tag created for the URL may be loaded by the catalog publisher with the URL for the catalog publisher's website. Thereafter, the catalog being published will be enabled to link to the website directly from any item having the URL tag associated with it. The same is true for telephone numbers and emails. Feedback and rating tags would be further linked to executable code for entering and receiving consumer ratings or consumer comments on the item display. The tag creation matrix is displayed in FIG. 13.

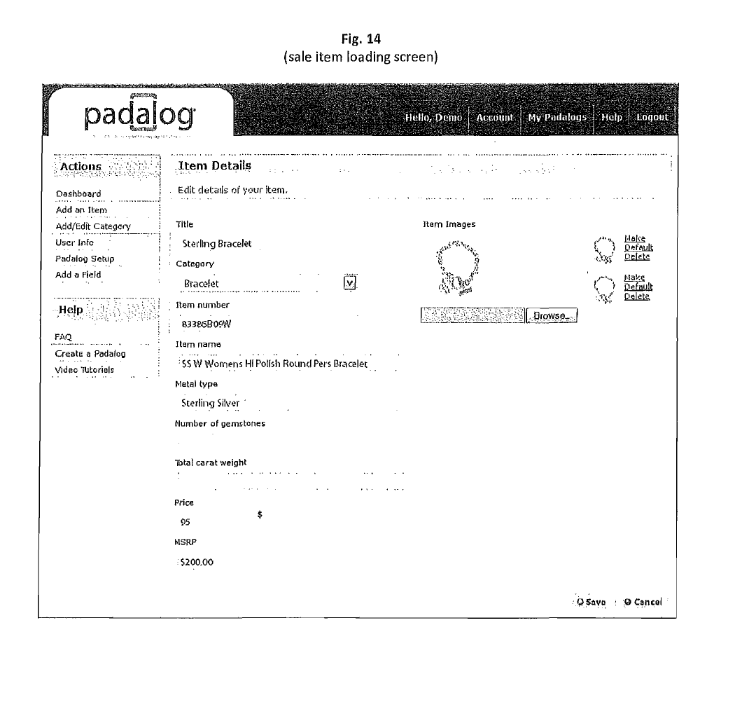

FIG. 14 depicts a sale item loading screen. On this page, the defined tags appear in the left-hand column, and a space is provided in a right-hand column for entry of text or numbers where appropriate. A separate page, or alternatively a separate position on the same item loading page, will provide for the catalog publisher to upload one or more images of the item for sale.

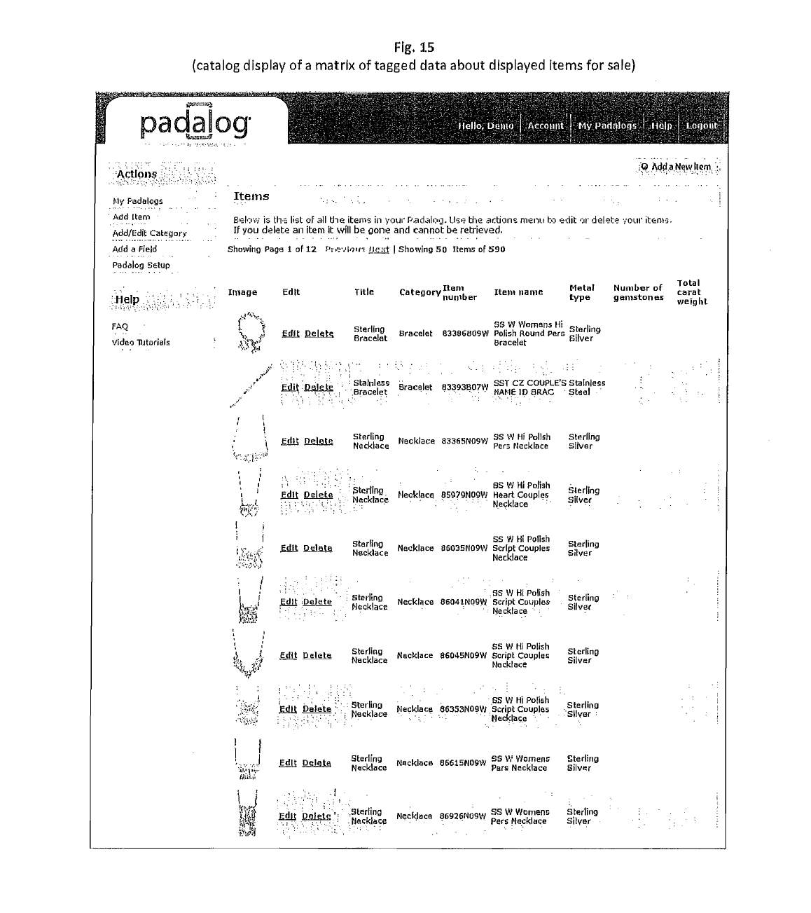

The result of configuring the tags is depicted in FIG. 15. There, the created tags become the column headings in the published catalog. Each of the tags selected or created by the catalog publisher will appear at the top of a column in the matrix. The rows of this matrix then become the individual items displayed for sale. As depicted, a thumbnail image of the particular item is one of the columns, preferably on the left. This is followed by text describing the item with respect to the particular tag under which the text appears. The catalog publisher may add as many items for display as he or she likes.

The consequence of the entirely flexible and scalable tagging function of the present invention is to enable a catalog viewer to search and sort the items in the catalog. In this respect, the viewer may include an ultimate consumer, a retail reseller of the items in the catalog, a sales person or a manufacturer's representative. The search or sorting process may include a menu displayed to a viewer having as many items on it as the catalog publisher has created tags. The search function may be executed by entering all search criteria at once. Alternatively, the search function may be iterative. That is to say, a person searching for a t-shirt may designate a color and size and style by filling in those fields all at once, or, alternatively, a viewer may select one of those variables first, and then search the results with a second variable.

By having multiple tags, hierarchical searching is enabled, for example and without limitation as a relational database. A user can request all blouses in a certain size. A particular color may be requested at the same time or in a further search of the items returned from the first search.

However, tagging also facilitates sorting and filtering. Tags may be ranked by the publisher upon entering them. A higher ranking may correspond to a higher level categorization.

Certain tags, such as color, may be linked to the display of an item. For example, a ring may be available with diamonds, rubies, emeralds or sapphires. The publisher may tag that ring with each of those identifications. The publisher may further be presented with display option selections such that the stone color displayed in the ring image may be changed according to an individual color tag being searched.

For each item, there will be configurable display options. The publisher may load text, images, video and/or executable files for display with each item. These may include the numbers of views of the item for sale on a screen, the number of alternate views associated with the initial view. Further options may include varying displays of the item selectable by a user, for example, different colors. Further options may include the combination of an item with different items. For example, a jeweler may want to offer a particular setting with optionally different stones in it, or optionally different coordinated jewelry items, such as rings, bracelets and necklaces.

Each of these display options may be related in configurable ways to an initial display screen. It is anticipated that the ultimate display tablet device, such as an iPad, will have a touch screen. Accordingly, the publisher may configure display options according to touch screen options. These may for example include scrolling left, right, up and down or touching buttons. These may be consistent throughout the display of all items in the catalog. For example, touching a stone in a jewelry display may call up color options in all display items. Another display option may be photos that are zoomable, providing for close up views of product details.

The present invention provides for rapid updating on all of these items, availability, etc. that is not possible with old style paper catalogs. Accordingly, the salesman making a sales call will be able to seamlessly communicate to the customer up-to-date and accurate data.

Returning now to FIG. 12 the catalog creation steps are illustrated. Having accessed 100 the catalog creation page, the catalog publisher may select category options 102. Thereafter the publisher may tag items as described above at step 104. The publisher enters functional tag items such as URL links, email addresses and phone numbers at step 106. At this stage, the publisher will be presented with display options 108. Having tagged data fields and formatted display options, the publisher begins to enter the sale items.

The user will provide images, for example photographs, and load these displays 110. Loading may for example be by cutting and pasting photographs or videos into a field display for receiving them on the website 112. Video access may be directly downloading a video or by accessing an externally hosted clip such as on YouTube™, the video display method being selected at step 114. Executable files may be loaded as a part of an individual items display. Next the catalog publisher would enter product data for the item currently being populated under the appropriate tags.

Merchandizing techniques may be incorporated. New items, best selling items or sale items may be labeled as such. Additionally, such items may be highlighted by displaying them in a preferred position chosen at step 116, or with a publisher selectable change in photo size and/or font size or color at steps 118 and 120 respectively.

Options are available for pricing at step 122. These may include simple pricing such as merely loading the prices for items. However a powerful advantage of the present invention is the controllability of pricing structures and the provision for authorizing salesmen to present alternative pricing structures to potential retail purchasers. Accordingly, the pricing options are selected at step 122. These options may include price matrixes which may provide prices varying, for example, according to volumes of items ordered. The pricing options may include a range, taking into account for example order volumes, the status of the item, such as discontinued items and other potential factors contributing to varying prices in order that a salesman would have the freedom and authority to build quotes. Access to some pricing may be restricted by password protection at step 124.

In this manner, a salesman's or manufacturers representative's detailed knowledge of customer preferences may be combined with the advantages of ecommerce systems for instant up-to-date and accurate product data for use during a sales call. The extent to which a salesman may be given that quoting authority may be entered by the publisher. Alternatively, the publisher and salesman may reach agreement on those topics offline and the publisher would not select pricing options through the system of the present invention.

Access to catalogs may be controlled and configured by the publisher. A particular catalogue may be public and accessible to all. It may alternatively be private and require a designation of a username and password to view and download it. An even more restrictive level may be controlled access. This would comprise pre-approval of a user, and that user's username and password. Accordingly the catalog would be so designated at 126. At subsequent visits to the network based administrative interface, applications for controlled access would be considered and approved or not.

Finally a publisher may opt for notices to be displayed to viewers of a particular catalog, or to particular known users of a particular catalog at 128. The notices may be designated at 130 as subject to user preference, or displayed regardless of user preference.

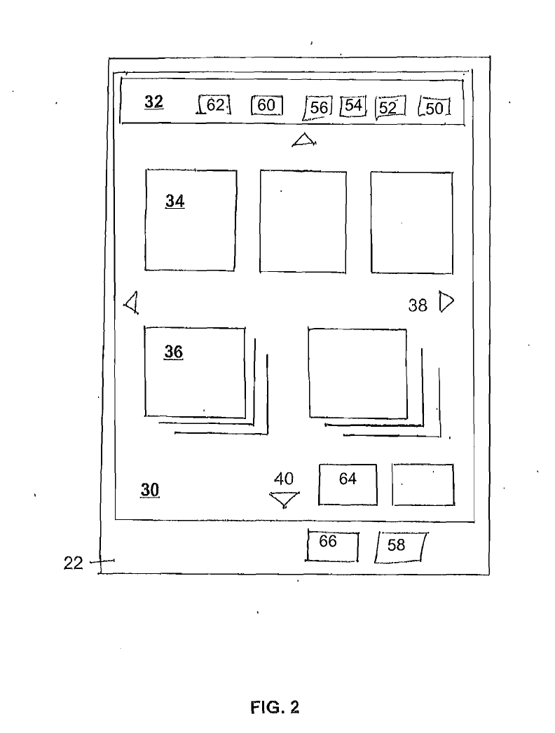

For each step of catalog creation, links to training videos 56 or help 54 (FIG. 2) may be displayed.

### Display

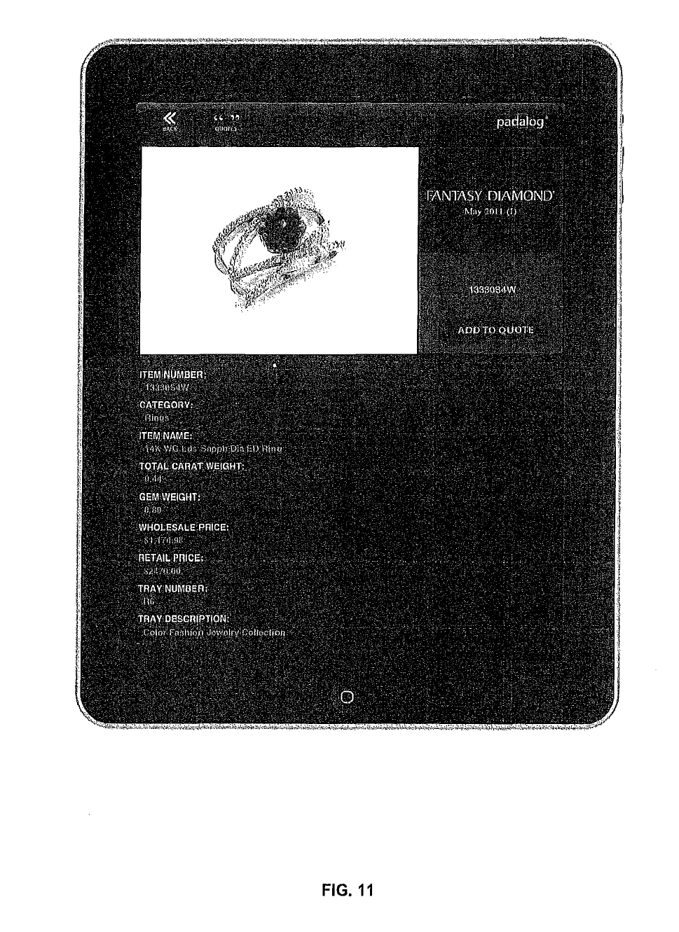

As seen in FIG. 2, the display 30 on a user's handheld device 22 shows items 34 chosen from the master inventory by the catalog publisher. These may displayed simply, or in a prioritized fashion 36. Text information organized by pre configured tags may be displayed as shown in FIG. 11.

With regard to who the viewer may be, the present invention affords the catalog publisher advantageous control of accessibility. Some fields may be designated as password protected. For example, as discussed above, pricing fields may be a publicly-published price followed by a second tag having a variable price that is only accessible by those who have been assigned a password, for example, sales persons. The password-protected price tag may display to the sales person wholesale pricing.

Sales people may therefore access a published catalog and download it all to a tablet computer or smart phone in preparation for a sales presentation. Further, sales people may be enabled by the catalog publisher to include in their presentation data within tags that are not available to the general public, such as wholesale pricing as described above. Other such material may include volume discounts or sales dates and prices.

A sales person preparing for a sales presentation, who may have specific knowledge of a retailer who may be specialty retailer interested only in certain product lines within a larger published catalog, may customize a catalog before downloading it to the tablet computer. Accordingly, the presenter, sales person would execute a search as described above, use the search to identify those tags corresponding to sales items that the retailer sells, and indicate that only the results of that search be downloaded into the salesman's tablet computer. Accordingly, only a focused, concise, catalog as customized for that individual retailer or viewer as configured by the sales person may be created. Thus an advantageous focus for the sales presentation may be created by the sales person. Such a technique further yields processing and computation advantages in that unnecessary material need not be loaded into the tablet computer's memory or searched through by its processor during the presentation. During presentation, the sales person may advantageously dispense with the necessity to access the internet, a burdensome requirement of prior art electronic catalogs and ecommerce websites, and dispense with cumbersome hard copy catalogs.

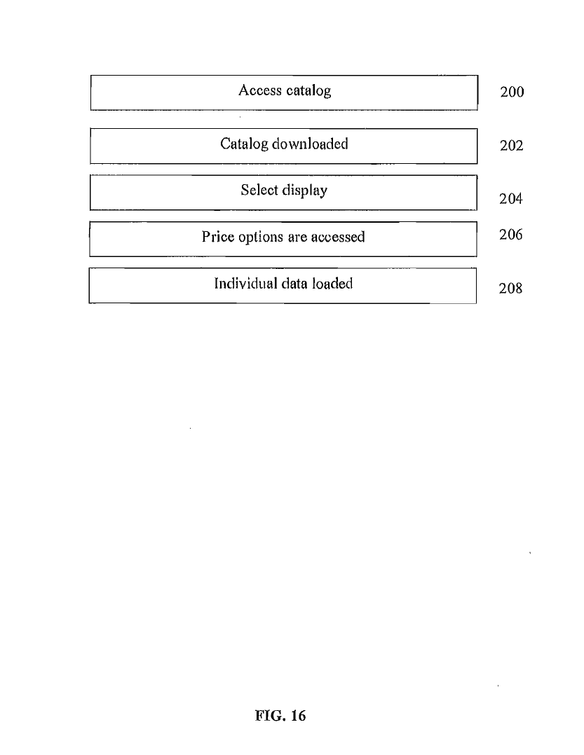

Referring now to FIG. 16, a salesperson or manufacturer's representative may access the catalog using the system of the present invention and load it onto his tablet computer in preparation for a sales call for a particular potential retail purchaser. Accordingly, the salesmen would access the website of the present invention and the catalog for the publisher/vendor he represents at step 200. From the catalogs offered by the vendor, the salesman will select one of our catalogs. That catalog is then downloaded 202 from the website to the salesman's tablet computer.

The salesman may, within the confines of a configurable authority for it previously configured by the vendor, manipulate the catalog to be shown to the potential purchaser. At this stage, the system of the present invention advantageously allows for the advantage of ecommerce, that is up-to-date product data and ease and repetitively of display with the advantages of traditional human presentation sales techniques, to-wit, the salesman's particular knowledge of a potential purchaser's preferences and agendas. Accordingly, the sales person may select for first display, prioritized display or no display certain groups of products or individual items at step 204.

As referenced above, the salesman may also be granted by the vendor/publisher authority within bounds configured by the vendor/publisher to build a price matrix. Price matrix refers to a price range for each individual item. This price range may provide for volume purchase discounts, special offers for discontinued items, sales and the like. These options are accessed by the salesman at step 206 and the individual data for an anticipated sales call is loaded at step 208. Thereafter, the salesman may select another catalog.

The invention is further comprised of multiple layout options, multiple display options such as colors or simulated textures sometimes referred to as “skins,” multiple other display options including prioritizations of catalog items, with higher priority items being displayed more prominently, and including any other visual display mode. The display enables the user to toggle between such display parameters. For example, on a touch screen, toggling left or right, such as with arrows 38, may display a different layout configuration for the catalog display, while toggling up and down, such as with arrows 40, may show the catalog in a variety of different colors. Throughout the display parameter choices, the inventory items displayed as content remain the same.

Further display options include multiple toggles. For example, a display screen may be divided into two or more sections, the first section for example comprising a title and a second section comprising a body of the display. The shifting or toggling in the title portion of the display may change the display between groups of display pages, for example a first catalog of multiple catalogs, or a first layout of a catalog among several layouts for the same catalog. In a separate geographic position on the display, shifting the body of the display may effect a change in the page of the display within the display group of pages that has previously been selected in the title block. In this way, a user may easily access a plurality of catalogs. Alternatively, in this way the user could easily choose between different display modes for the same catalog.

With the capabilities of the system of the present invention, users can browse and search through all public catalogs and load or delete catalogs from the user's mobile device, and make additional catalogs from available data with field attributes assigned by the publisher. For instance, a user may view items from multiple catalogs and select those items for inclusion into a catalog made by the user, although the user would have a limited ability to modify the information for each item selected. This user catalog could then be viewed by third parties. For publishers, the catalogs may be edited from within the system application, which editing function may optionally be browser-based.

### Other Capabilities

The invention may also be used to display text or image data in a series of tiles, which may be rearranged by the user, such as to form a complete message or image. A series of screen shots for this embodiment are pictured in FIG. 11.

The present invention is consistent with and capable of providing ratings by users and the display of the ratings, including cumulative rating results. Cumulative scores and trends may be displayed.

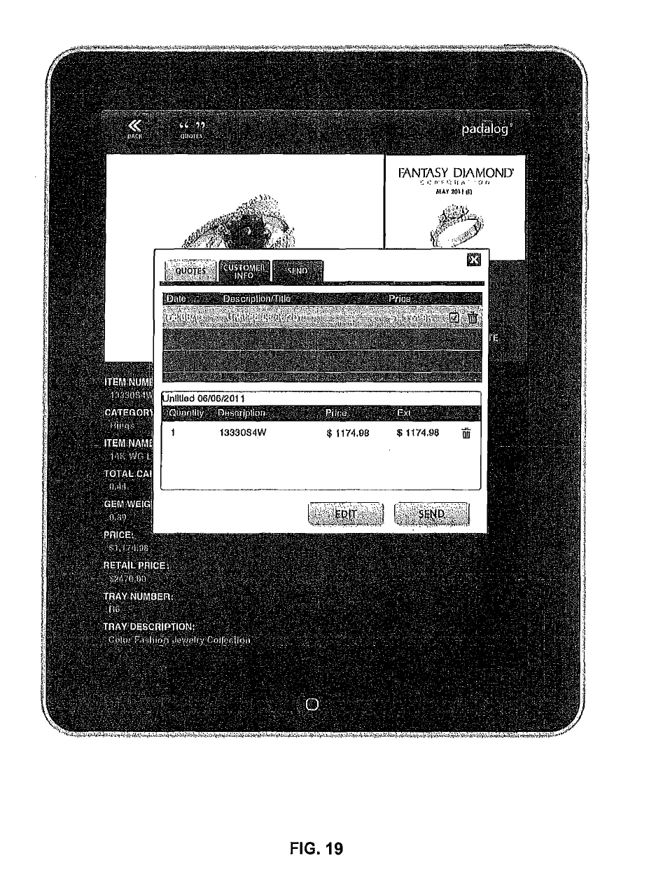

The present system provides for feedback from multiple decision makers, recommenders and commenters to the items displayed in a particular catalog. A provision may be made to type in notes and comments. Toward this or other ends, product item information may be shared. Product item images and data may be emailed to others via a display option to do so, as seen at 50. FIG. 19 depicts a quote for an item that may be shared by email or otherwise with another. Product item images and data may be shared through social media networks such as Facebook™, again by a user selecting a displayed option therefore, at 52. In the event that the sharing selections are made during an off line viewing of the catalog, the selection, email and/or sharing designation will be cached or spooled until the user's tablet computer accesses the internet again.

Non-publisher users, such as commenters, may be given access to change one or more fields or items within the catalog, as configured by the publisher. For example, volunteers working at an auction may enter donations as inventory items in a first field, a current price bid in another field associated with that item, and/or payments and delivery requirements in additional fields.

E-commerce is enabled with the present invention. In the depicted embodiments, functional tags are used to enter and then display URLs so that a user can link to a website for e-commerce. Moreover, the link may be made to a publisher's ordering and payment gateway, such as for example authorize.net, or third party services such as PayPal™.

The catalog may optionally include a shopping cart 19 and ability to purchase using any compatible e-commerce method now known or hereafter invented.

Feedback may include editing of items displayed by the user. Accordingly, certain items the user may not want may be deleted from a downloaded copy of the catalog. Edits such as deletion of an item may be through a direct editing feature as configured by a publisher. For example a user may be enabled to click on an item to delete it, such as on a touch screen. Editorial choices may include deletion, but may also include prioritization of items, linking of items that may be best used together, or disassociation of items that are disadvantageous if used together. Users may further create wish lists, and send links 15 and data copied from the catalog (for example in PDF form) to third parties via email or uploads to third party sites such as social networking sites (for example, Facebook).

A configuration of the catalog may include automatic responses to user editorial choices. For example, deletions may yield an automatic display of more or different inventory items or choices, as for example a feature common to the selected items may be used to select all items in the master inventory having those features. These may then be displayed to the user. In addition, advertisements may be sent to users, including advertisements from an advertisement database 17 selected on the basis of user searches, or items reviewed or selected by the user.

The display of the catalog may also be configured to incorporate data from one or more external sources that are accessible via the Internet. A publisher may elect to cause an http or ftp server to be accessed by the invention, and data, such as product inventory levels, would be retrieved and presented within the catalog. This data could be fetched in real-time upon demand, initiated by the act of viewing the catalog. Or it could occur at pre-determined intervals, such as nightly, and the retrieved information would be written to a database and pushed to the smartphone or tablet computer.

In the event that multiple users/purchasers may be viewing the catalog contemporaneously, the editorial choices of each purchaser may be displayed to all purchasers. Accordingly, where a presentation of capabilities or exemplary work of the publisher is being presented to a user that is a partnership or other entity having multiple purchasing decision makers, one decision maker can access editorial changes in the catalog that have been made by a different decision maker.

Hence the system, apparatus and method of the present invention is advantageously interactive. An editorial choice by a user can change a catalog, which may then be changed further by the catalog publisher in a way responsive to the user's edits, which changed catalog may in turn be changed again by another user—decision maker. Commenters may enter comments in a provided field, and may be configured by the publisher to have catalog editorial rights, or only access to enter comments. In this way, the catalog may advantageously iterate towards a conclusive choice.

Varying degrees of control may be used by the publisher of the catalog. For example, a basic catalog may be used for personal use, and catalog items may be as simple as family photos to be shared with family, friends or colleagues. Basic catalogs may further be used for broad distribution, as for example charitable organizations or by fans of athletic teams. Publishers using the application to create catalogs may pay for only those features they choose to use.

A higher level of publisher application use may provide for commercial features, such as the ability to make purchases over the network, the ability to distribute inventory sales and communication data with a sales force. A wish list, shopping cart, item rating and private data, accessible either with or without entry of a security code, may be enabled. Distribution lists according to a UDID mobile device ID number may be enabled.

Catalogs may be created for specific targeted users/customers or clients. Associations may be established between items based on interactivity or possible common interest.

Help may be optionally available and displayed. Display 54 of a help menu may be automatic through a certain number of views by a new user, and thereafter not displayed but selectable through a menu request. A help option may be live call in by phone or alternatively videoconferencing, again by selecting a displayed option 56. Links to related items 60 may be displayed. Rating entries 62 may be displayed. Links to order and/or shipping status 64 may be displayed.

A shopping cart 66 as used on Internet e-commerce sites may be provided. Execution of an order would be when the application in the tablet computer is in its connected state, either at the time of purchase, or if the purchase order is entered when the tablet computer application is in its disconnected state, to be saved and forwarded the next time the application is in its connected state.

Product item identification may be facilitated by bar code scanning. A scanner may be integrated within the smart phone or tablet computer as at 58, or the data from a scan may be received by the application of the present invention from an outside source. The alphanumeric strings yielded from a scan of either a bar code or a Quick Response (“QR”) two dimensional product identifier code, may be used to call up and display a cataloged product item having the corresponding SKU number. Alternatively, at the stage of loading the catalog, the publisher may designate a bar or QR code tag, and associate any product item in the catalog with a particular bar or QR code, as for example one of the publisher's products that competes with another vendor's product having the scanned bar code. The publisher may configure the catalog to download and/or display, in response to a scanned and decoded QR Code, a specified Padalog, open a specified Padalog, select a specific category of products for view, filter for a pre-defined selection of products, conduct a product search, or combinations of these functions, each by associating that function with the bar or QR code in the appropriate tag tuple.

The display of the catalog may also be configured to include QR codes, for display of those codes at a time and in a manner configurable by the publisher. A reporting/analytics database 28 may be established to record relevant viewing and order information about users, such as total number of users, aggregate number of page views, number of views for specific pages, top exit pages, session time, and other metrics.

Padalog publishers would be given the option to implement one or more entertainment functions within their Padalogs. These would be features designed to increase the level of user engagement with the publisher's product content and/or to occupy the user during processing delays, but would not directly impact the way that product information is displayed and accessed by the user. Such features may include trivia games, puzzles, the display of quotations or sayings, graphic displays or animations, and the like.

Coupons and promotions are enabled. Publishers may tag 132 and thereby automatically display with a particular item a coupon and my further stop displaying/offering that coupon based on preconfigured redemption parameters such as active date ranges and purchase qualifications, or creating temporary price reductions for a defined time period or until a volume threshold is reached, as at 134.

### Display Algorithm

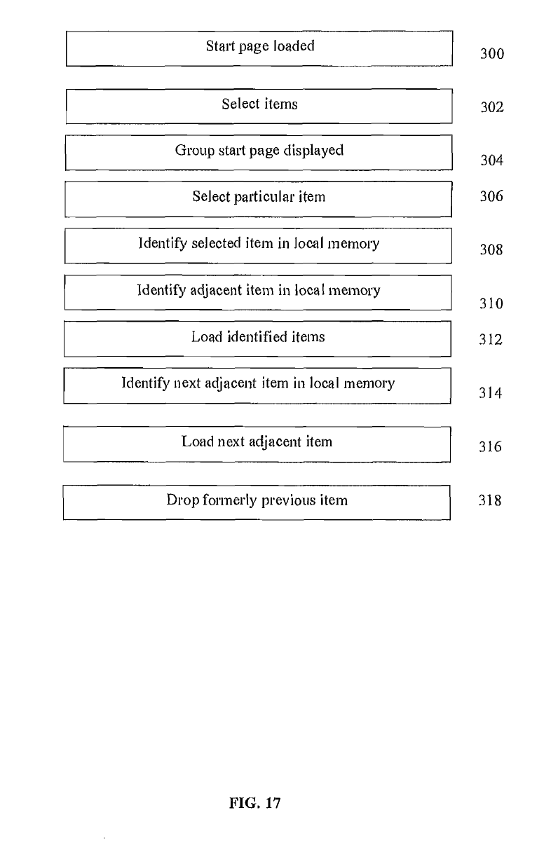

Presenting what may be an extremely large volume of data and display items for sales call in a convenient electronic format such as the system of the present invention provides cannot be achieved simply by combining currently existing ecommerce website structures with a portable device. A technical difficulty arises in that the portability of devices like a tablet computers and smart telephones is achieved by their limited hardware capabilities. Both memories and processing power are smaller and lower than what may be achieved on websites backed by full size computers and servers. Accordingly, display of the catalogs on the tablet device is managed according to FIG. 17. FIG. 17 depicts an advantageous technique for curtailing the amount of data to be loaded in a dynamic short term memory for immediate display, since the full volume of data for an entire catalog is likely too much for the capabilities of most smart phones and tablet computers. The display algorithm of the present invention on the tablet device or smart phone is in one embodiment achieved by writing a mirrored SQL database in the iPad for the display of items from a particular catalog. With the SQL regime, the previous and next items for display are cached.

After the smart phone or tablet computer has been turned on and that catalog has a start page loaded at step 300 to begin a display session. From the start screen, a particular group of items or item is selected at step 302. If a group is selected, a group start page is displayed at step 304. Thereafter a particular item is selected for display at step 306, this item will have associated with it the preconfigured display options, including additional photographs with varying views, links to associated products, product data such as availability and price, all of which may be further displayed by the viewer as described hereinabove. In order to accommodate viewer expectations, a next or previous item must be immediately available for immediate display by scrolling, as by swiping left or right on a touch screen. Accordingly, at the item selection step 306, the system and method of the present invention identifies in the loaded catalog memory the selected item at step 308 and thereafter identifies the adjacent items that may be displayed in memory as well. Typically, but not exclusively, two adjacent items may be identified which is the previous and next items in the catalog. After the adjacent item identification step 310, all identified items, typically three, are loaded into the dynamic memory of the device at step 312. In this manner, a viewer may scroll forwards or backwards among the items and immediately see the next item without any lag time for loading it. However, because only three items are loaded, the processor of the smart phone or tablet device is not overburdened. Hence, at this stage, there is an item displayed on the tablet computer and loaded into the dynamic short term memory of the processor a group or start page “above” the item being displayed, further information such as link or product data displays “below” the item being displayed in alternate views available by scrolling. Also available for immediate display are the adjacent and previous items, their associated product data and alternate views. At some point, the viewer will turn from the displayed item to a next displayed item. At this point, the system and method of the present invention returns to the catalog database and long term memory and identifies the new adjacent item, a next item for display, at step 314. This new item is loaded into the processor's dynamic short term memory at step 316. Contemporaneously with loading the new item, the formerly previous item, now remote from the item currently being displayed, is dropped from the processor's dynamic short term memory at step 318. In this manner, the amount of data to be managed by the processor and short term memory is controlled.

In another embodiment, the entire catalog is not downloaded at all. Where internet access is available to the tablet computer or smart phone, the displayed items and next and previously displayed items may be downloaded directly from a website. For direct access to a website, a shopping cart may be available and purchasing options also made available.

The combination of the two capabilities, accessing a website or not, provides an advantageous option for the presenter person, salesperson; sales calls may be advantageously made and products presented without access to the internet. Where the internet options are not selected, the salesman may bypass often problematic issues with booting the computer, accessing the local internet access, such as Wi-Fi which frequently requires a host provider code to be discovered and the like.

In an alternate embodiment, a customer may want to receive price quotations from a sales person, without immediately committing to a purchase. There may be saved from the display session a separate memory of quotes that were made, including the various price matrix incentives for sales volume discounts and the like. As may be selected by the vendor/publisher and/or sales person, the quote may be designated as being available for a certain timeframe.

### Exemplary Uses

Exemplary uses of the invention may include any commercial activities offering stock inventories. However, commercial endeavors offering more customized products or services may take advantage of the interactivity features. For example, florists, wedding consultants, pastry chefs, interior and kitchen design contractors and the like may show examples of work, configure specific fields for users to enter preferences and may respond to designation by the user of a particular example of work and other preferences to display a possible custom item for purchase.

Other businesses may make use of third party commenter capabilities. For example, a talent agency could display a stable of actors available for a casting call. Thereafter, the results of the casting call, including videos of the auditions, may be displayed to users to make choices, for example, the producers. Other interested parties, for example, the director, may have different interactivity rights, for example, the right to comment but not choose.

Dealers of a wide variety of commercial lines of goods from antiques to auto parts may make advantageous use of the display capabilities and capability of linking various inventory items that may be advantageously purchased together.

Commercial endeavors catering to discreet or private uses may advantageously use this system to create catalogs with very limited access. For example, cosmetic surgeons could show examples of work, with before and after pictures, that may be viewed in complete privacy by a prospective patient. Instructional tutorials may be displayed. Questions may be entered and answered.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. An electronic catalog apparatus to display items selected by a presenter from among items published by a publisher for viewing by a viewer comprising:
said apparatus having a connected state and a disconnected state;
said connected state allowing access to a master database of items through a network and said disconnected state not having said access;
when in said connected state, said apparatus having a processor configured to store in a local memory at least two items, each of said items having at least one interactive tag and at least one data point;
said items being selected by the presenter from said master database accessed by said processor through said network during said connected state;
said items being configurable by said presenter during said connected state, wherein said configurability of said items by said presenter includes an item selection from among a plurality of items in said master database, and a data point selection from among a plurality of data points for each of said items in said master database; and when in said disconnected state, said selected items being retained in said local memory;
said processor having a display element configured to display at least one of said data points in response to a query received by said processor from the viewer according to one of said interactive tags such that only said selected items are available for response to said query.

2. The electronic catalog apparatus of claim 1 wherein said interactive tags are searchable, catagorizable designations of each of said items, designated such that said viewer may retrieve said data points for all of said items that are responsive to a query based on one or more of said interactive tags.

3. The electronic catalog apparatus of claim 1 wherein said data points include at least one of a price of said item, an image of said item, an item text description of said item.

4. The electronic catalog apparatus of claim 3 wherein said text description of said item includes at least one of an item characteristic, a unique product identification and a title.

5. The electronic catalog apparatus of claim 1 wherein said interactive tags include interoperability with elements outside a computer on which said electronic catalog apparatus is embodied, including at least one of a link to a network location associated with said item, a scanable unique product identifier for said item, an availability of said item, an email address and email content field, a postable link to a network site, a ranking, and a purchase order.

6. (canceled)

7. The electronic catalog apparatus of claim 1 wherein said processor is configured such that selectable ones of said items, said data points or said interactive tags are not configurable by a presenter, according to a limitation on said selectable ones placed by said publisher of said master database.

8. The electronic catalog apparatus of claim 7 wherein said processor is configured such that said limitation on said selectable ones of said items placed by said publisher of said master database is a limitation placed on a publisher selectable individual presenter or a publisher selectable group of presenters.

9. The electronic catalog apparatus of claim 7 wherein said processor is configured such that said limitation is a limitation on a price for an selected item.

10. The electronic catalog apparatus of claim 1 wherein said display element is further configured to upload to a RAM a current display of a current item in response to a display prompt by a viewer, and to further upload to said RAM one next display of one next item, said next item being adjacent to said current item in a display prompt queue called from said local memory such that said RAM is not loaded with more than a current display and a next display of items responsive to a display prompt by a viewer.

11. The electronic catalog apparatus of claim 9 wherein said display prompt by a viewer is a search according to said interactive tags.

12. The electronic catalog apparatus of claim 1 wherein each of said items may be shared by a viewer with other viewers via posting to a remote network site or via email.

13. The electronic catalog apparatus of claim 1 further comprising said processor being configured to transmit to a central server associated with said master database an input from one of the presenter or the viewer entered when said processor is in said disconnected state upon said processor next being in said connected state.

14. The electronic catalog apparatus of claim 13 wherein said input is a purchase order.

15. The electronic catalog apparatus of claim 1 further comprising said processor being configured to modify said selected items in said local memory according to a modification entered by the publisher entered when said processor is in said disconnected state upon said processor next being in said connected state.

16. The electronic catalog apparatus of claim 15 wherein said modification is at least one of a price change or an availability change.

17. An electronic catalog publication apparatus to display items selected by a presenter from among items published by a publisher for viewing by a viewer comprising:
a central server and a central memory, said central memory having a master database storing a plurality of items comprising a master electronic catalog;
each of said items having at least two interactive tags, and each of said interactive tags being associated for each item with a data point for that item;
said server being configured such that said interactive tags are configurable by said publisher of said master electronic catalog to include any number of interactive tags and any content within each of said interactive tags for each item in said master electronic catalog;
said server being further configured such that said interactive tags for each item are separately populated with said data points associated with respective ones of said items;
said server being further configured to transfer to a remote computer selected ones or selected groups of said items upon access to said central server by a presenter and upon request of said ones or groups of items by said presenter;
said transfer of said selected items including said interactive tags and said data points.

18. The electronic catalog publication apparatus of claim 17 further comprising said transfer of said selected items from said master database to the remote computer is limited to designated ones or groups of said items, said interactive tags or said data points, said designations of transferable items, tags and data being configurable by the publisher.

19. The electronic catalog publication apparatus of claim 18 further comprising said designations of transferable items, tags and data is configurable by the publisher according to an identity of the presenter.

20. The electronic catalog publication apparatus of claim 17 wherein said interactive tags are searchable, catagorizable designations of each of said items designated such that said viewer may retrieve said data points for all of said items responsive to a query based on one or more of said interactive tags.

21. The electronic catalog publication apparatus of claim 17 wherein said data points include at least one of a price of said item, an image of said item, an item text description of said item.

22. The electronic catalog apparatus of publication claim 21 wherein said text description of said item includes at least one of an item characteristic, a unique product identification and a title.

23. The electronic catalog publication apparatus of claim 17 wherein said interactive tags include interoperability with elements outside a computer on which said electronic catalog apparatus is embodied, including at least one of a link to a network location associated with said item, a scanable unique product identifier for said item, an availability of said item, an email address and email content field, a postable link to a network site, a ranking, and a purchase order.

24. The electronic catalog publication apparatus of claim 17 wherein said configurability of said items by said presenter includes an item selection from among a plurality of items in said master database, and a data point selection from among a plurality of data points for each of said items in said master database.

25. The electronic catalog publication apparatus of claim 17 wherein said server is further configured to transfer to the remote computer a display element, said display element being further configured to upload to a RAM a current display of a current item in response to a display prompt by a viewer, and to further upload to said RAM one next display of one next item, said next item being adjacent to said current item in a display prompt queue called from said local memory such that said RAM is not loaded with more than a current display and a next display of items responsive to a display prompt by a viewer.

26. The electronic catalog publication apparatus of claim 25 wherein said display prompt by a viewer is a search according to said interactive tags.

27. The electronic catalog publication apparatus of claim 17 wherein each of said items may be shared by a viewer with other viewers via posting to a remote network site or via email.

28. The electronic catalog publication apparatus of claim 18 wherein said designation of a transfer limitation limits transfer of a price matrix to only prices designated by the publisher.

29. A display method for displaying selected ones of a plurality of items available for display from an electronic catalog wherein each item includes at least two interactive tags and at least two data points, wherein said display is on an electronic display device having less processing and memory capacity than a computer from which said plurality of items for display were downloaded into a local memory of said electronic display device, said method comprising;
receiving from a viewer a display prompt;
identifying within said local memory of said electronic display device items responsive to said display prompt;
identifying a first item for display from among said responsive items;
identifying an adjacent item for display, said adjacent item for display being adjacent to said first item for display;
loading into a RAM of said electronic display device only a display of said first item for display and a display of said adjacent item for display; and
displaying said first item.

30. The method of claim 29 further comprising:
when the viewer chooses to view said adjacent item for display, identifying in said local memory a next adjacent item for display from the items responsive to said display prompt;
loading into said RAM of said electronic display device said display of said next adjacent item for display; and
displaying said adjacent item.

31. The method of claim 30 further comprising:
saving in said RAM said first item for display as a previous item.

32. The method of claim 31 further comprising:
when each new item is selected for viewing by the viewer, discarding all items from said RAM except a current item displayed, a previous item displayed and a next item for display.

33. The method of claim 29 wherein said display prompt is a search of said electronic catalog according to an interactive tag.
